(19) United States
(12) Patent Application Publication
(10) Pub. No.: US 2024/0198785 A1
(43) Pub. Date: Jun. 20, 2024

(54) POWER TRANSMISSION DEVICE

(71) Applicant: Dong-Hoon PARK, Seongnam-si (KR)

(72) Inventor: Dong-Hoon PARK, Seongnam-si (KR)

(21) Appl. No.: 18/507,257

(22) Filed: Nov. 13, 2023

(30) Foreign Application Priority Data
Nov. 14, 2022 (KR) 10-2022-0151230
Nov. 17, 2022 (KR) 10-2022-0154213
Nov. 18, 2022 (KR) 10-2022-0155063
Nov. 18, 2022 (KR) 10-2022-0155064
Nov. 10, 2023 (KR) 10-2023-0155332

(51) Int. Cl. B60K 7/00; B60K 17/04

(52) U.S. Cl. CPC B60K 7/0007; B60K 17/046; B60K 2007/0038

(57) ABSTRACT

Disclosed is a power transmission device.

The power transmission device may include: a drive motor including a motor housing, a stator fixed into the motor housing and generating a magnetic field, a rotor disposed inside the stator in a radial direction while having a predetermined gap with the stator and rotated by the magnetic field generated by the stator, a motor shaft coupled to the rotor to be rotated together with the rotor and extending in a length direction, and a first pinion gear disposed at one end of the motor shaft that protrudes outward from the motor housing; a drum surrounding the drive motor by including a drum disk portion disposed on one surface in a wheel axis direction and a cylindrical portion extending from an outer diameter end of the drum disk portion in the wheel axis direction; a drum cover coupled to the other surface of the drum in the wheel axis direction, and having a ring gear disposed on its outer diameter and meshed with the first pinion gear; a wheel hub installed with a tire, and coupled to the drum to be rotated together with the drum; and a second pinion gear meshed with the ring gear.

### TECHNICAL FIELD

The disclosure relates to a power transmission device, and more particularly, to a power transmission device which may be used in a wheel drive unit or the like.

### BACKGROUND ART

In recent years, the use of an eco-friendly vehicle such as a hybrid vehicle and an electric vehicle is increasing due to tightened environmental regulation and fuel economy regulation. The eco-friendly vehicle may include an electric motor as a power source, and various types of eco-friendly vehicles can be implemented based on dispositions of the electric motor and a reducer.

One of the various disposition methods of the power source for the eco-friendly vehicles may be a method of using a wheel drive unit in which the power source is disposed in or near a wheel hub. A conventional wheel drive unit may have a large size, and a portion of the wheel drive unit may protrude outside the wheel hub. Such a portion of the wheel drive unit that protrudes to the outside the wheel hub may cause interference with a vehicle part such as a suspension or a braking device. Accordingly, a design change in a vehicle body or a chassis may be required to install the conventional wheel drive unit on the vehicle.

An in-wheel motor system has been developed to solve this problem. The in-wheel motor system may be a system in which the electric motor, which is the power source, and the reducer are disposed in the wheel hub. A conventional in-wheel motor system may mainly use a planetary gear set as its reducer. However, it is difficult to dispose the electric motor, the planetary gear set, and a wheel bearing in the wheel hub. Accordingly, an in-wheel motor system including no reducer has been developed.

However, the in-wheel motor system including no reducer may require a large-capacity electric motor because the vehicle is required to be launched and driven at a high speed by power of the electric motor itself. As a result, the in-wheel motor system may consume a lot of power, thus causing a limit to a distance in which the vehicle can be driven on a single charge. The system is required to use a large-capacity battery to compensate for this problem.

Meanwhile, according to conventional technology, one pinion gear included in a reduction device may rotate a ring gear, stress may be concentrated on one pinion gear, thus lowering durability of the reduction device. In addition, a road impact occurring while the vehicle is driven may be also transmitted directly to one pinion gear through the ring gear, thus further lowering the durability of the reduction device.

The above information disclosed in this Background section is provided only to assist in more understanding of the background of the disclosure, and may thus include information not included in the prior art already known to those skilled in the art to which the disclosure pertains.

### DISCLOSURE

### Technical Problem

The disclosure attempts to provide a power transmission device in which a driving force of a drive motor is transmitted to a ring gear through two pinion gears, thereby reducing stress acting on each pinion gear and improving durability of a reduction device.

In addition, the disclosure attempts to provide a power transmission device in which a road impact is distributed and transmitted to two pinion gears through a ring gear.

### Technical Solution

According to an aspect of the disclosure, a power transmission device includes: a drive motor including a motor housing, a stator fixed into the motor housing and generating a magnetic field, a rotor disposed inside the stator in a radial direction while having a predetermined gap with the stator and rotated by the magnetic field generated by the stator, a motor shaft coupled to the rotor to be rotated together with the rotor and extending in a length direction, and a first pinion gear disposed at one end of the motor shaft that protrudes outward from the motor housing; a drum surrounding the drive motor by including a drum disk portion disposed on one surface in a wheel axis direction and a cylindrical portion extending from an outer diameter end of the drum disk portion in the wheel axis direction; a drum cover coupled to the other surface of the drum in the wheel axis direction, and having a ring gear disposed on its outer diameter and meshed with the first pinion gear; a wheel hub installed with a tire, and coupled to the drum to be rotated together with the drum; and a second pinion gear meshed with the ring gear.

In some embodiments, the device may further include: a drive gear disposed on the other end of the motor shaft that protrudes outward from the motor housing; a driven shaft disposed to be parallel to the motor shaft; and a driven gear disposed at one end of the driven shaft and meshed with the drive gear, wherein the second pinion gear is disposed at the other end of the driven shaft.

A gear ratio of the first pinion gear and the second pinion gear may be 1:1.

The motor shaft and the driven shaft may be spaced apart from a horizontal line in opposite directions.

A center line of the motor shaft may be spaced apart from the horizontal line by a first separation distance, and a center line of the driven shaft may be spaced apart from the center line of the motor shaft by a second separation distance.

In another embodiment, a drive motor may further include a planetary gear set disposed at the other end of the motor shaft to be operably connected to the motor shaft, and operably connected to the ring gear of the drum cover through the second pinion gear to transmit power of the motor shaft to the drum cover.

The planetary gear set may be a double planet planetary gear set, and include: a sun gear fixedly installed at the other end of the motor shaft and rotated together with the motor shaft; first and second planet gears operably connected to the sun gear to be rotated around the sun gear; a planet carrier supporting the first and second planet gears to be rotatable, rotated by rotations of the first and second planet gears, and fixedly installed with the second pinion gear meshed with the ring gear; and a planet ring gear fixed to the motor housing and having an inner peripheral surface meshed with the second planet gear.

A motor shaft hole may be formed in the length direction in the other end of the motor shaft, and the planet carrier may extend in the length direction such that one end portion of the planet carrier is relatively rotatably inserted into the motor shaft hole.

A bearing can be disposed between one end of the planet carrier and the motor shaft hole.

The gear ratio of the first pinion gear and the second pinion gear may be 1:1, and the number of teeth of the planet ring gear can be twice the number of teeth of the sun gear.

In another embodiment, the device may further include a second drive motor including a second motor housing, a second stator fixed into the second motor housing and generating the magnetic field, a second rotor disposed inside the second stator in the radial direction while having a predetermined gap with the second stator and rotated by the magnetic field generated by the second stator, a second motor shaft coupled to the second rotor to be rotated together with the second rotor and extending in the length direction, and a second pinion gear disposed at the other end of the second motor shaft that protrudes outward from the second motor housing.

The gear ratio of the first pinion gear and the second pinion gear may be 1:1, and a rotation speed of the first motor shaft and a rotation speed of the second motor shaft may be the same as each other.

In another embodiment, the power transmission device may further include an idle gear device rotated by the second pinion gear meshed with the ring gear rotated by the first pinion gear.

The idle gear device may include: an idle shaft extending in the length direction, including one end and the other end, and having the second pinion gear, which is meshed with the ring gear, fixedly installed at the other end; and a bearing support cover fixedly installed at the other end of the motor housing, wherein the other end of the idle shaft penetrates through the bearing support cover, and the bearing support cover supports the idle shaft to be rotatable.

A motor shaft hole may be formed in the length direction in the other end of the motor shaft, and the one end portion of the idle shaft may be relatively rotatably inserted into the motor shaft hole.

The bearings may respectively be disposed between the motor shaft hole and one end of the idle shaft, and between the idle shaft and the bearing support cover.

The drive motor and the idle gear device may be disposed on a horizontal line, or disposed to be spaced apart from the horizontal line.

### Advantageous Effect

According to the disclosure, it is possible to transmit the driving force of the drive motor to the ring gear through the two pinion gears, thereby reducing the stress acting on each pinion gear. It is thus possible to improve the durability of the reduction device.

It is also possible to distribute and transmit the road impact to the two pinion gears through the ring gear. A shock of the road impact may be distributed and transmitted, thus further improving the durability of the reduction device.

Other effects which may be acquired or predicted by the embodiments of the disclosure are disclosed directly or implicitly in the detailed description of the embodiments of the disclosure. That is, various effects predicted based on the embodiments of the disclosure are disclosed in the detailed description described below.

### DESCRIPTION OF THE DRAWINGS

Embodiments in the specification may be better understood by referring to the following description in connection with the accompanying drawings in which similar reference numerals refer to identical or functionally similar elements.

FIG. 1 is a front view of a power transmission device according to an embodiment of the disclosure.

FIG. 2 is a side view of the power transmission device according to an embodiment of the disclosure.

FIG. 3 is a cross-sectional view taken along a line A-A of FIG. 1.

FIG. 4 is a cross-sectional view taken along a line B-B of FIG. 2.

FIG. 5 is a cross-sectional view taken along the line B-B of FIG. 2 in a power transmission device according to a second embodiment of the disclosure.

FIG. 6 is a cross-sectional view taken along the line B-B of FIG. 2 in a power transmission device according to a third embodiment of the disclosure.

FIG. 7 is a cross-sectional view taken along the line B-B of FIG. 2 in a power transmission device according to a fourth embodiment of the disclosure.

FIG. 8 is a cross-sectional view taken along the line B-B of FIG. 2 in a power transmission device according to a fifth embodiment of the disclosure.

It should be understood that the drawings referenced above are not necessarily drawn to scale, and present a rather simplified representation of various preferred features showing the basic principles of the disclosure. For example, specific design features of the disclosure, including its specific dimension, orientation, position, and shape, are determined in part by the particular intended application and environment of use.

### Mode for Invention

Terms in the specification are used to describe specific embodiments, and are not intended to limit the disclosure. Terms of a singular number used in the specification are intended to include its plural number unless the context clearly indicates otherwise. It is to be understood that terms “comprise,” or “include” used in the specification specify the presence of features, numerals, steps, operations, elements and/or components, and do not preclude the presence or addition of one or more other features, numerals, steps, operations, components and/or groups thereof. The term “and/or” used herein includes any one or all combinations of one or more associated listed items. A term “coupled” used herein indicates a physical relationship between two components directly connected to each other, or indirectly connected to each other through one or more medium components.

A “coupling means” or a similar term may indicate a means for coupling at least two members to be rotated together. An example of the coupling means may be a bolt, a nut, welding, press-fitting, an adhesive, a spline, or the like, and is not limited thereto.

An expression “operably connected” or a similar expression may indicate that at least two members are directly or indirectly connected to each other to thus transmit power. However, two members operably connected to each other may not be always rotated at the same speed and in the same direction.

It should be understood that a term used herein such as “a vehicle,” “of a vehicle” or another similar term generally refers to a passenger vehicle including a sports utility vehicle (SUV), a bus, a truck, any of various commercial vehicles, a vessel including any of various boats and ships, a truck, an aircraft, or the like, and also refers to a hybrid electric vehicle, an electric vehicle, a plug-in hybrid electric vehicle, a hydrogen powered vehicle, or a vehicle using another alternative fuel (e.g., fuel acquired from a resource other than petroleum). As referenced herein, the electric vehicle (EV) is a vehicle having electric power acquired from a rechargeable energy storage device (e.g., one or more rechargeable electrochemical cells or another type of battery) as a part of its driving force. The electric vehicle (EV) is not limited to an automobile, and may include a motorcycle, a cart, a scooter, or the like. In addition, a hybrid vehicle is a vehicle (e.g., hybrid electric vehicle (HEV)) having two or more power sources, e.g., gasoline-based power and electricity-based power.

Further, it is to be understood that one or more of methods described below or aspects thereof may be executed by at least one or more controllers. The term “controller” may refer to a hardware device including a memory and a processor. The memory may store program instructions, and the processor may be specifically programmed to execute the program instructions to perform one or more processes described below in more detail. The controller may control operations of units, modules, parts, devices, or the like, as described herein. It is also to be understood that the methods described below may be executed by a device including the controller in conjunction with one or more other components, as appreciated by those skilled in the art.

Hereinafter, the disclosure is described in detail with reference to the accompanying drawings.

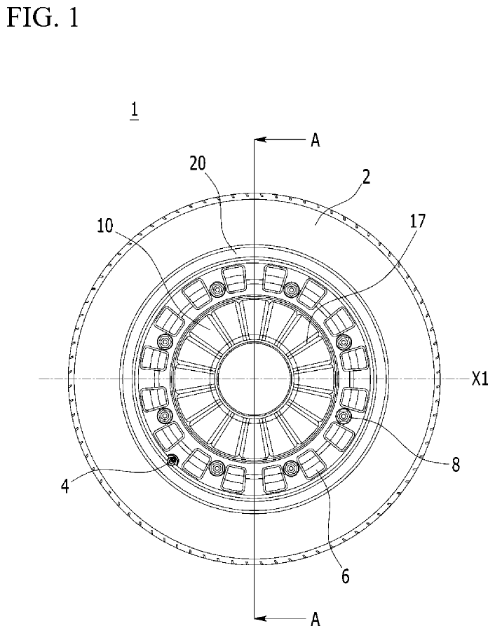

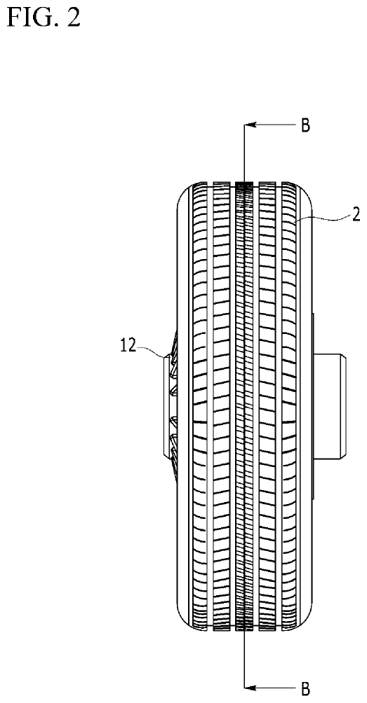

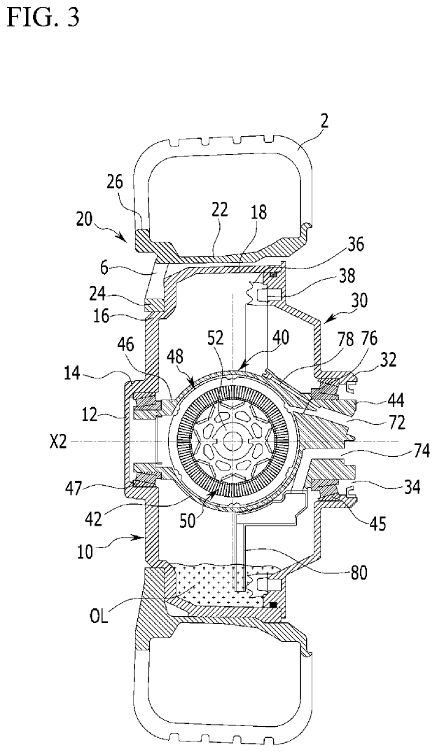

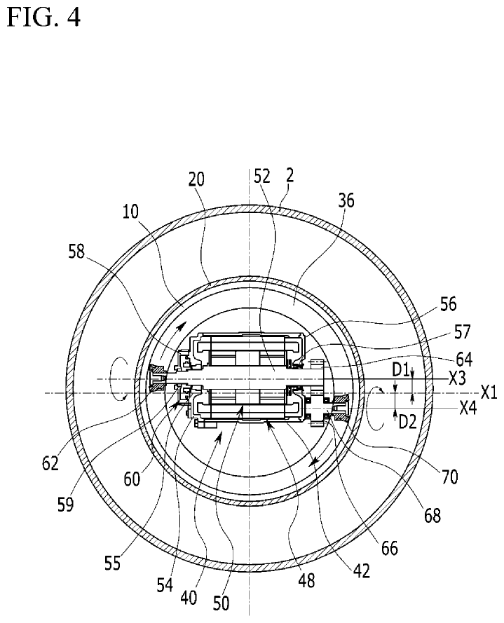

FIG. 1 is a front view of a power transmission device according to an embodiment of the disclosure; FIG. 2 is a side view of the power transmission device according to an embodiment of the disclosure; FIG. 3 is a cross-sectional view taken along a line A-A of FIG. 1; and FIG. 4 is a cross-sectional view taken along a line B-B of FIG. 2.

As shown in FIGS. 1 to 4, a power transmission device 1 according to an embodiment of the disclosure may be installed in a wheel and function as a wheel drive unit. The power transmission device 1 may include a drum 10, a drum cover 30, a wheel hub 20, and a drive motor 40.

The drum 10 may have a space for installing the drive motor 40, and have a substantially cylindrical shape surrounding the drive motor 40. The drum 10 may include a drum disk portion 12 and a drum cylindrical portion 18.

The drum disk portion 12 may have a substantial disk shape, may be disposed on one surface of the drum 10 in a wheel axis direction X2, and may include first and second step portions 14 and 16. The first step portion 14 may be disposed radially inside the drum 10 than the second step portion 16. That is, the drum disk portion 12 may extend outward from a wheel axis in a radial direction, extend from the first step portion 14 to the other side in the wheel axis direction X2, extend outward again in the radial direction, extend again from the second step portion 16 to the other side in the wheel axis direction X2, and extend outward again in the radial direction. The first step portion 14 may face a bearing support 46 in the radial direction. A bearing 47 may be disposed between the first step portion 14 and the bearing support 46, and the drum 10 may be disposed to be rotatable with respect to the drive motor 40. The drum disk portion 12 may be formed integrally or provided separately with coupling means such as a bolt 8 for its coupling with the wheel hub 20. As shown in FIG. 1, the drum disk portion 12 may have at least one drum rib 17, which extends in the radial direction, between the first step portion 14 and the second step portion 16. The drum rib 17 may not only reinforce rigidity of the drum 10, but also serve as a fin for dissipating heat occurring in the drum 10 to the outside of the drum 10.

The drum cylindrical portion 18 may extend from an outer diameter end of the drum disk portion 12 to the other side in the wheel axis direction X2. Accordingly, the drum 10 may have a space for installing the drive motor 40 therein. The wheel hub 20 may be disposed on an outer peripheral surface of the drum cylindrical portion 18, and the drum cylindrical portion 18 can thus support the wheel hub 20. As shown in FIG. 3, predetermined positions on the outer peripheral surface of the drum cylindrical portion 18 in a circumferential direction may each be spaced apart from an inner peripheral surface of the wheel hub 20, thus providing an air passage formed therebetween and extending in the wheel axis direction X2. The air passage may be communicated with an air inlet 6 of the wheel hub 20, and accordingly, air introduced between the wheel hub 20 and the drum 10 through the air inlet 6 of the wheel hub 20 may pass through the air passage and cool oil in the drum 10.

As shown in FIG. 3, the other surface of the drum 10 in the wheel axis direction X2 may be open, and the drum cover 30 may be coupled to the other surface of the drum 10. The drum cover 30 may have a substantial disk shape, and have a drum cover hole 34 formed in its center. The outer diameter end of the drum cover 30 may be in contact with the other end of the drum cylindrical portion 18 of the drum 10, and coupled thereto through the coupling means such as the bolt. A sealing member may be disposed between the outer diameter end of the drum cover 30 and the other end of the drum cylindrical portion 18 of the drum 10 to prevent oil in the drum 10 from leaking out of the drum 10.

The drum cover 30 may include a drum cover seat 32. The drum cover seat 32 may extend from a radial inner end of the drum cover 30 to the other side in the wheel axis direction X2 to form the drum cover hole 34. The drum cover hole 34 may be provided for connecting the drive motor 40 to a vehicle body (or chassis) or a suspension. In more detail, a motor arm 44 of the drive motor 40 may protrude outward from the wheel hub 20 through the drum cover hole 34 to be fixed to the vehicle body (or chassis) or the suspension. A bearing 45 may be disposed between an inner peripheral surface of the drum cover hole 34 and the motor arm 44, and the drum cover 30 can thus be rotated with respect to the drive motor 40.

A ring gear 36 may be disposed on one surface of an outer diameter of the drum cover 30. The ring gear 36 may be manufactured separately from the drum cover 30 and coupled to the drum cover 30 through the coupling means such as the bolt and/or the spline, or may be formed integrally with the drum cover 30. When the ring gear 36 is manufactured separately from the drum cover 30 and coupled to the drum cover 30 through the coupling means, a spacer 38 may be disposed between the drum cover 30 and the ring gear 36. The spacer 38 may adjust a backlash or the like between first and second pinion gears 62 and 70 and the ring gear 36. In one example, the ring gear 36 may be formed as the ring gear of a spiral bevel gear.

The ring gear 36 may be meshed with the first and second pinion gears 62 and 70 in the wheel axis direction X2. Accordingly, the drum cover 30 may receive power from the drive motor 40 to be rotated around the wheel axis, and the drum 10 coupled to the drum cover 30 may also be rotated around the wheel axis by this power. In addition, the bearing 47 may be disposed between the first step portion 14 of the drum 10 and the bearing support 46 of a motor housing 42, and the bearing 45 may be disposed between the inner peripheral surface of the drum cover hole 34 and the motor arm 44 of the motor housing 42. Therefore, the motor housing 42 may be fixed to the chassis, the vehicle body, or the suspension, while the drum 10 and the drum cover 30 can be smoothly rotated.

The number of gear teeth of the ring gear 36 may be greater than the number of gear teeth of each of the first and second pinion gears 62 and 70. Therefore, the vehicle may have a reduced rotation speed in a process of transmitting power from the drive motor 40 to the drum cover 30. That is, according to an embodiment of the disclosure, the vehicle may acquire a reduction gear ratio necessary for its launch or high-speed driving through the first and second pinion gears 62 and 70 and the ring gear 36, which are meshed with each other. Therefore, the small and lightweight power transmission device 1 can be implemented using the reduction device with a simple structure.

Each of the first and second pinion gears 62 and 70, or the ring gear 36 may be a bevel gear, the spiral bevel gear, or the like. In this way, the power transmission device 1 according to an embodiment of the disclosure can acquire the necessary reduction gear ratio with only the two pinion gears 62 and 70 and one ring gear 36, thus achieving higher power transmission efficiency compared to a wheel drive system using a planetary gear and a multi-stage reducer. In addition, power of the drive motor 40 may be transmitted to the ring gear 36 through the two pinion gears 62 and 70, thereby reducing stress acting on each of the two pinion gears 62 and 70. Further, a road impact can also be distributed and transmitted to the two pinion gears 62 and 70 through the ring gear 36. Accordingly, each of the two pinion gears 62 and 70 and the ring gear 36 can have improved durability.

The wheel hub 20 may be operably connected to the drum 10 to receive power from the drum 10. The wheel hub 20 may be rotated about the wheel axis to finally output the power. The wheel hub 20 may have a substantially cylindrical shape, and include a shoulder part 22, a coupling part 24, and a tire installation part 26. The shoulder part 22, the coupling part 24, and the tire installation part 26 may be formed integrally with each other.

The shoulder part 22 may extend in the wheel axis direction X2 to form a space where the power transmission device 1 can be disposed. The shoulder part 22 may define an axial width of the wheel hub 20, and at least the drive motor 40, the drum 10, and the drum cover 30 can be mostly disposed in the axial width defined by the shoulder part 22. Accordingly, it is possible to minimize parts disposed outside the axial width of the wheel hub 20, thereby minimizing interference between the power transmission device 1 and the vehicle part. Therefore, the power transmission device 1 may be very easily installed on the vehicle chassis or the vehicle body. A predetermined position of the shoulder part 22 may be spaced apart from the drum cylindrical portion 18 in the circumferential direction, while another position of the shoulder part 22 can be pressed into the drum cylindrical portion 18 of the drum 10.

The coupling part 24 may extend radially inward from one end of the shoulder part 22, and may be pressed into the drum disk portion 12 of the drum 10 or coupled thereto through the coupling means such as the bolt 8. As shown in FIGS. 1 and 3, the plurality of air inlets 6 may be formed at the coupling part 24 in the circumferential direction, and the air inlet 6 may be communicated with the air passage. Therefore, air introduced between the wheel hub 20 and the drum 10 through the air inlet 6 may cool the oil in drum 10 while passing through the air passage.

The tire installation part 26 may protrude outward in the radial direction from each of two ends of the shoulder part 22 in the wheel axis direction X2. A tire 2 may be installed on tire installation part 26. The tire 2 may be a rubber tire, a urethane wheel, or the like.

An air injection device 4 may be installed at the wheel hub 10 to inject air into the tire 2.

As shown in FIGS. 3 and 4, the drive motor 40 may be connected to a power source such as a battery (not shown) to generate power to drive the vehicle, and may be the electric motor including the motor housing 42, a stator 48, a rotor 50, and a motor shaft 52.

The motor housing 42 may have a through cylindrical shape with an open front surface, a side surface, and an open rear surface, and form an installation space for installing the stator 48 and the rotor 50 in such a manner that a front cover 54 is coupled to the open front surface through the coupling means such as the bolt, and a rear cover 56 is coupled to the open rear surface through the coupling means such as the bolt. In one example, the drive motor 40 may be disposed horizontally. That is, a center line X3 of the motor shaft 52 in a length direction may be disposed to coincide with or be parallel to a horizontal line X1 horizontal to the ground passing through the center of the wheel.

A front cover hole 55 may be formed in the front cover 54, and a rear cover hole 57 may be formed in the rear cover 56. The motor shaft 52 may extend in the length direction and pass through the front cover hole 55 and the rear cover hole 57, the first pinion gear 62 may be fixedly disposed at a front end of the motor shaft 52, and a drive gear 64 may be fixedly disposed at a rear end of the motor shaft 52. The bearing and the sealing member may respectively be disposed between the front cover hole 55 and the motor shaft 52, and between the rear cover hole 57 and the motor shaft 52. The bearing may assist a smooth rotation of the motor shaft 52, and the sealing member may prevent oil in the motor housing 42 from leaking out of the motor housing 42.

As shown in FIGS. 3 and 4, the motor housing 42 may include the motor arm 44 and the bearing support 46 each extending from the side surfaces of the motor housing 42 in the wheel axis direction X2. The bearing support 46 may extend from the side surface to one side in the wheel axis direction X2, and the motor arm 44 may extend from the side surface opposite to the bearing support 46 to the other side in the wheel axis direction X2.

The motor arm 44 may have one end integrally formed with the motor housing 42, and the other end extending to the other side in the wheel axis direction X2 to extend out of the wheel hub 20 through the drum cover hole 34. The other end of the motor arm 44 may be fixed to the vehicle body (or chassis) or the suspension, for example, a knuckle, through a flange or the like.

The drive motor 40 may be fixed to the suspension or the vehicle body such as the knuckle through the motor arm 44. In this case, the road impact occurring when the vehicle is driven, or a wheel impact occurring in sudden acceleration or sudden braking may not be directly transmitted to the part in the motor housing 42, such as the stator 48 or the rotor 50, thereby improving the durability of each of the drive motor 40 and the related parts. In addition, the bearing 45 may be disposed between the inner peripheral surface of the drum cover hole 34 and the motor arm 44 to enable the drum cover 30 to be smoothly rotated with respect to the motor arm 44.

The bearing support 46 can have the other end formed integrally with the motor housing 42, and one end extending to the other side in the wheel axis direction X2 and extending to the drum disk portion 12. The bearing 47 may be disposed between the first step portion 14 and the bearing support 46 to enable the drum 10 to be smoothly rotated with respect to the bearing support 46.

In addition, when the bearing support 46 and the motor arm 44 are formed on the two sides of the motor housing 42 in the wheel axis direction X2, the bearing support 46 and the motor arm 44 may support the two sides of the drive motor 40 to prevent the road impact or the like from being directly transmitted to the drive motor 40, thereby further improving the durability of the drive motor 40.

As shown in FIGS. 3 and 4, the stator 48 may be disposed in the motor housing 42 and fixed to the motor housing 42. The stator 48 may be connected to the power source to generate a magnetic field, and include a stator core and a stator coil surrounding the stator core. A structure of the stator 48 is well known to those skilled in the art, and the description thus omits any further detailed description thereof.

The rotor 50 may be disposed inside the stator 48 in the radial direction while having a predetermined gap with the stator 48. The rotor 50 may be rotated by the magnetic field generated by the stator 48. In one example, a permanent magnet may be attached to or embedded in an outer diameter of the rotor 50. The drive motor 40 including the rotor 50 may be referred to as a permanent magnet synchronous motor (PMSM). However, it is to be understood that the specification only exemplifies one type of the drive motor 40, and that the disclosure is not limited to the type of drive motor 40 exemplified in the specification.

The motor shaft 52 may penetrate through the center of the rotor 50, and extend along the center line X3 of the motor shaft 52 in the length direction. The motor shaft 52 may be coupled to the rotor 50 to be rotated together with the rotor 50. In one example, the rotor 50 may be coupled to the motor shaft 52 by the spline or a key.

The drive motor 40 may be provided with a resolver 60 measuring a rotation speed of the motor shaft 52, that is, a rotation speed of the drive motor 40, by generating a change in a physical value (e.g., a change in a magnetic pole or the magnetic field) corresponding to the rotation speed of the motor shaft 52. The resolver 60 may include a resolver rotor attached to the motor shaft 52 and a resolver stator installed on the front cover 54.

A resolver cover 58 may be further installed on a front surface of the front cover 54 to protect the resolver stator. The resolver cover 58 may surround the resolver stator, and can be fixed to the front cover 54 through the coupling means such as the bolt.

A resolver cover hole 59 may be formed in an upper center of the resolver cover 58, and the front end of the motor shaft 52 may pass through the resolver cover hole 59 and extend to the front side of the resolver cover hole 59.

An inner peripheral surface of the resolver cover hole 59 and an outer peripheral surface of the motor shaft 52 may be spaced apart from each other, and the sealing member may be disposed therebetween to prevent oil from penetrating into a space formed by the resolver cover 58 and the motor shaft 52.

As described above, the front end of the motor shaft 52 may pass through the front cover hole 55 of the front cover 54 to protrude outward from the front cover 54, and the first pinion gear 62 meshed with the ring gear 36 may be disposed at the front end of the motor shaft 52 that protrudes outward from the front cover 54. The first pinion gear 62 may be manufactured separately from the motor shaft 52 to be coupled to the front end of the motor shaft through the coupling means such as the fixing bolt and/or the spline, or may be formed integrally with the motor shaft 52. In one example, the first pinion gear 62 may be formed as the pinion gear of the spiral bevel gear. The rear end of the motor shaft 52 may pass through the rear cover hole 57 of the rear cover 56 to protrude outward from the rear cover 56, and the drive gear 64 may be disposed at the rear end of the motor shaft 52 that protrudes outward from the rear cover 56. The drive gear 64 may be manufactured separately from the motor shaft 52 to be coupled to the rear end of the motor shaft through the coupling means such as the fixing bolt and/or the spline, or may be formed integrally with the motor shaft 52.

The power transmission device 1 may further include a driven shaft 68 disposed in the space in the drum 10. The driven shaft 68 may be disposed to be parallel to the motor shaft 52. A driven gear 66 meshed with the drive gear 64 may be disposed at a front end of the driven shaft 68. The driven gear 66 may be manufactured separately from the driven shaft 68 to be coupled to the front end of the driven shaft 68 through the coupling means such as welding and/or the spline, or may be formed integrally with the driven shaft 68. The second pinion gear 70 meshed with the ring gear 36 may be disposed at a rear end of the driven shaft 68. The second pinion gear 70 may be manufactured separately from the driven shaft 68 to be coupled to the rear end of the driven shaft 68 through the coupling means such as the fixing bolt and/or the spline, or may be formed integrally with the driven shaft 68. In one example, the second pinion gear 70 may be formed as the pinion gear of the spiral bevel gear. In this way, power of the drive motor 40 may be transmitted to the ring gear 36 through the two pinion gears 62 and 70, thereby reducing the stress acting on each of the two pinion gears 62 and 70. Further, the road impact can also be distributed and transmitted to the two pinion gears 62 and 70 through the ring gear 36. Accordingly, each of the two pinion gears 62 and 70 and the ring gear 36 can have the improved durability.

In order to transmit power of the drive motor 40 to the ring gear 36 through the two pinion gears 62 and 70, a gear ratio of the drive gear 64 and the driven gear 66 may be 1:1, and a gear ratio of the first pinion gear 62 and the second pinion gear 70 can also be 1:1.

Meanwhile, the motor shaft 52 and the driven shaft 68 may be disposed to be spaced apart from the horizontal line X1. For example, the center line X3 of the motor shaft 52 may be spaced apart from the horizontal line X1 by a first separation distance D1, and a center line X4 of the driven shaft 68 may be disposed to be opposite to the center line X3 of the motor shaft 52 based on the horizontal line X1, and spaced apart from the horizontal line X1 by a second separation distance D2.

In an embodiment of the disclosure, when the ring gear 36 is rotated, rotation directions of the first and second pinion gears 62 and 70 need to be opposite to each other. The rotation direction of the second pinion gear 70 may be opposite to the rotation direction of the first pinion gear 62 through the drive gear 64 and the driven gear 66.

Hereinafter, in the following embodiments, the rotation directions of the first and second pinion gears 62 and 70 are opposite to each other by various methods.

As shown in FIG. 3, the power transmission device 1 according to an embodiment of the disclosure may further include a cooling device for cooling the drive motor 40. The cooling device of the power transmission device 1 may be connected to an external cooling system (not shown) of the power transmission device 1 to receive oil from the cooling system, and heated oil while cooling the parts in the power transmission device 1 may be discharged to the cooling system. Therefore, oil may be circulated through the external cooling system and the cooling device of the power transmission device 1.

The motor arm 44 of the drive motor 40 may be provided with a supply passage 72 and a discharge passage 74. Oil may be supplied into the drive motor 40 through the supply passage 72, and discharged from the power transmission device 1 through the discharge passage 74. The discharge passage 74 may be connected to a suction motor (not shown), and the suction motor may suction oil in the drum 10 through the discharge passage 74.

The motor arm 44 may have first and second oil supply holes 76 and 78 formed therein and connected to the supply passage 72. The first oil supply hole 76 may supply oil supplied into the drive motor 40 through the supply passage 72 in the circumferential direction. Oil supplied through the first oil supply hole 76 may cool the stator 48.

The second oil supply hole 78 may supply oil supplied into the drive motor 40 through the supply passage 72 to the front end of the drive motor 40. Oil supplied to the front end of the drive motor 40 can be flowed from the front to the rear along the motor shaft 52.

A suction pipe 80 may be further disposed on a side of the motor housing 42. The suction pipe 80 may have a free end disposed in the drum 10 to be lower than an oil level OL to suck the oil in the drum 10. An oil filter may be installed in the suction pipe 80 to filter out a foreign material in suctioned oil. In addition, the suction pipe 80 may be connected to the suction motor through the discharge passage 74. Accordingly, when the suction motor is operated, oil in the drum 10 may be suctioned through the suction pipe 80, and oil may be discharged to the outside of the power transmission device 1 through the discharge passage 74. Oil may be cooled while passing through the external cooling system, and then supplied back into the power transmission device 1 through the supply passage 72. Meanwhile, a magnet may be attached to the suction pipe 80 to catch iron particles in the oil.

Meanwhile, oil temporarily stored in a lower portion of the drum 10 may be rotated together with the drum 10, introduced between the wheel hub 20 and the drum 10 through the air inlet 6 of the wheel hub 20, and cooled by air passing through the air passage.

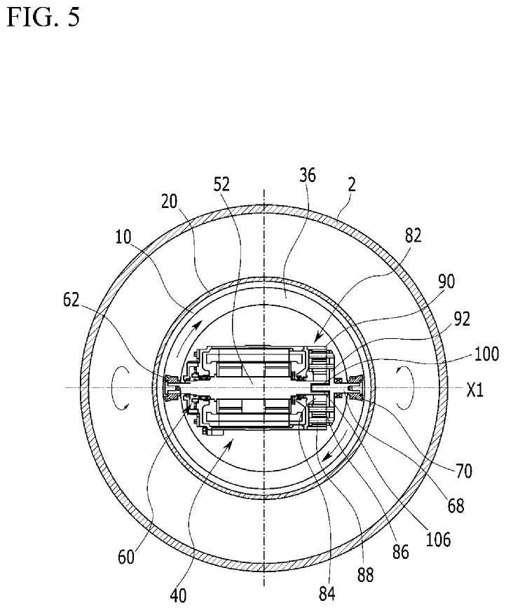

FIG. 5 is a cross-sectional view taken along the line B-B of FIG. 2 in a power transmission device according to a second embodiment of the disclosure. A power transmission device 1 according to a second embodiment of the disclosure is similar to the power transmission device 1 according to an embodiment of the disclosure except for a drive motor 40. Therefore, only the drive motor 40 is described in detail.

As shown in FIG. 5, the drive motor 40 of the power transmission device 1 according to a second embodiment of the disclosure may further include a planetary gear set 82 disposed at the other end of the motor shaft 52 to be operably connected to the motor shaft 52, and operably connected to the ring gear 36 of the drum cover 30 to transmit power of the motor shaft 52 to the drum cover 30.

The planetary gear set 82 may be a double planet planetary gear set, and include a sun gear 84, first and second planet gears 86 and 88, a planet carrier 92, and a planet ring gear 90. The sun gear 84 may be fixedly installed at the other end of the motor shaft 52 and rotated together with the motor shaft 52. The first planet gear 86 may be meshed on an outer peripheral surface of the sun gear 84 and rotated around the sun gear 84. The second planet gear 88 may be meshed on an outer peripheral surface of the first planet gear 86, meshed on an inner peripheral surface of the planet ring gear 90, and rotated around the sun gear 84 together with the first planet gear 86. The planet ring gear 90 may be fixedly installed at the motor housing 42 or the rear cover 56. The planet carrier 92 may support the first and second planet gears 86 and 88 to be rotatable. A motor shaft hole 100 may be formed in the center of the other end of the motor shaft 52 in the length direction (that is, the horizontal line X1), the planet carrier 92 may extend to the front and the rear in the length direction (that is, the horizontal line X1), and a front portion of the planet carrier 92 may be inserted into the motor shaft hole 100. A bearing 106 may be disposed between the front portion of the planet carrier 92 and the motor shaft hole 100 to assist a smooth rotation of the planet carrier 92. The second pinion gear 70 meshed with the ring gear 36 may be disposed at a rear end of the planet carrier 92. The second pinion gear 70 may be manufactured separately from the planet carrier 92 to be coupled to the rear end of the planet carrier 92 through the coupling means such as the fixing bolt and/or the spline, or may be formed integrally with the planet carrier 92.

The number of teeth Zr of the planet ring gear 90 may be twice the number of teeth Zs of the sun gear 84 to ensure a smooth rotation of the ring gear 36 when the gear ratio of first pinion gear 62 and second pinion gear 70 is 1:1.

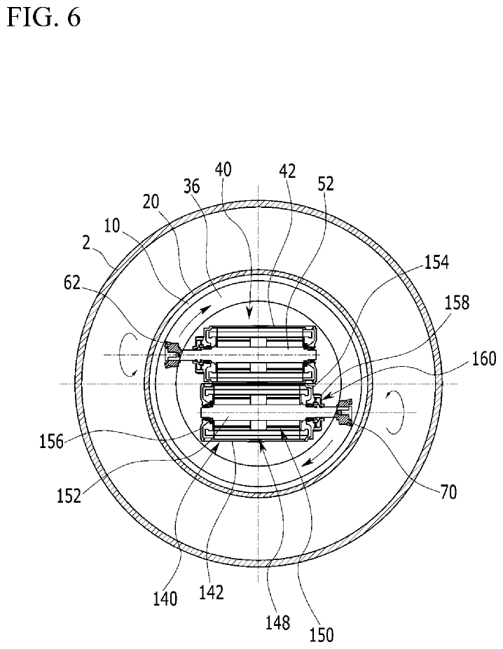

FIG. 6 is a cross-sectional view taken along the line B-B of FIG. 2 in a power transmission device according to a third embodiment of the disclosure. A power transmission device 1 according to a third embodiment of the disclosure is similar to the power transmission device 1 according to an embodiment of the disclosure except for a drive motor 40. Therefore, only the drive motor 40 is described in detail.

As shown in FIG. 6, the power transmission device 1 according to a third embodiment of the disclosure may further include a second drive motor 140 meshed with the ring gear 36 through the second pinion gear 70 and transmitting power to the drum cover 30. The second drive motor 140 may include a second motor housing 142, a second stator 148, a second rotor 150, a second motor shaft 152, a second front cover 154, a second rear cover 156, and a second resolver cover 158, and a second resolver 160. A structure of the second drive motor 140 is very similar or identical to that of the drive motor 40, and the description thus omits any further detailed description thereof. The second drive motor 140 may be attached to or spaced apart from the drive motor 40, and the second drive motor 140 can rotate the ring gear 36 through the second pinion gear 70 fixed to the second motor shaft 152.

Here, in order to smoothly rotate the ring gear 36 in a state where the gear ratio of the first pinion gear 62 and the second pinion gear 70 is 1:1, the rotation speed of the first motor shaft 52 and a rotation speed of the second motor shaft 152 may be the same as each other.

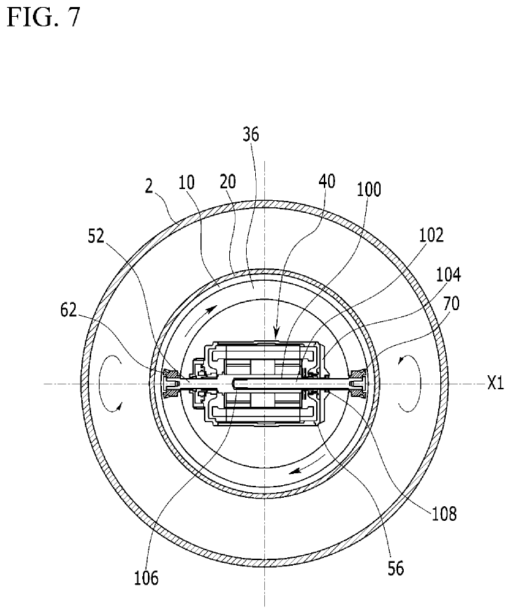

FIG. 7 is a cross-sectional view taken along the line B-B of FIG. 2 in a power transmission device according to a fourth embodiment of the disclosure. A power transmission device 1 according to a fourth embodiment of the disclosure is similar to the power transmission device 1 according to an embodiment of the disclosure except for a drive motor 40. Therefore, only the drive motor 40 is described in detail.

As shown in FIG. 7, the power transmission device 1 according to a fourth embodiment of the disclosure may further include an idle gear device rotated by the ring gear 36 rotated by the first pinion gear 62, and receiving a reaction force. The idle gear device may include an idle shaft 102, a bearing support cover 104, and the second pinion gear 70. In addition, the motor shaft hole 100 may be formed in the center of the other end of the motor shaft 52 in the length direction (that is, the horizontal line X1), the idle shaft 102 may extend in the length direction (that is, the horizontal line X1), and a front portion of the idle shaft 102 may be inserted into the motor shaft hole 100. The bearing 106 may be disposed between the front portion of the idle shaft 102 and the motor shaft hole 100 to assist a smooth rotation of the idle shaft 102. The bearing support cover 104 may be installed on a rear surface of the rear cover 56. The bearing support cover 104 may be formed integrally with the rear cover 56, or may be manufactured separately from the rear cover 56 and attached to the rear cover 56. The rear end of the idle shaft 102 may extend to the rear by penetrating through the bearing support cover 104, and the second pinion gear 70 may be fixedly installed on the idle shaft 102 at the rear of the bearing support cover 104. The second pinion gear 70 may be meshed with the ring gear 36, and support the rotated ring gear 36. Meanwhile, a bearing may be installed between the bearing support cover 104 and the idle shaft 102 to smoothly assist a rotation of the idle shaft 102.

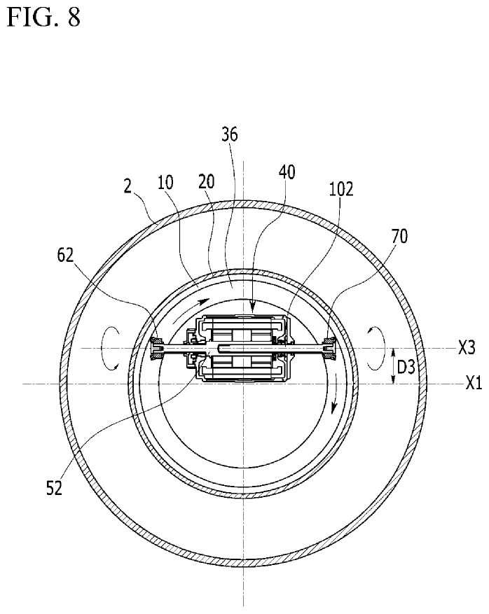

FIG. 8 is a cross-sectional view taken along the line B-B of FIG. 2 in a power transmission device according to a fifth embodiment of the disclosure. A power transmission device 1 according to a fifth embodiment of the disclosure is similar to the power transmission device 1 according to a fourth embodiment of the disclosure except for a position of the drive motor 40. Therefore, only the position of the drive motor 40 is described in detail.

As shown in FIGS. 7 and 8, the drive motor 40 and the idle gear device according to a fourth embodiment of the disclosure may be disposed on the horizontal line X1, while the drive motor 40 and the idle gear device according to a fifth embodiment of the disclosure may be spaced apart from the horizontal line X1 by a third separation distance D3. That is, the center line X3 of the motor shaft 52 may be spaced apart from the horizontal line X1 by the third separation distance D3.

In this way, when the first pinion gear 62 and the second pinion gear 70 are spaced apart from the horizontal line X1, which is a central axis of the ring gear 36, a mesh rate of the gears may be increased and the stress may be reduced, thereby increasing a lifespan of the gear 62, 70, or 36.

Although the embodiments of the disclosure have been described hereinabove, the scope of the disclosure is not limited thereto, and all equivalent modifications easily modified by those skilled in the art to which the disclosure pertains are intended to fall within the scope and spirit of the disclosure.

### DESCRIPTION OF SYMBOLS

| | |
|---|---|
| 1power delivery device | 2: tire |
| 4: air injection device | 6: air inlet |
| 8: bolt | 10: drum |
| 12: drum disk portion | 14: first step portion |
| 16: second step portion | 17: drum rib |
| 18: drum cylindrical portion | 20: wheel hub |
| 22: shoulder part | 24: coupling part |
| 26: tire installation part | 30: drum cover |
| 32: drum cover seat | 34: drum cover hole |
| 36: ring gear | 38: spacer |
| 40: drive motor | 42: motor housing |
| 44: motor arm | 45, 47: bearing |
| 46: bearing support | 48: stator |
| 50: rotor | 52: motor shaft |
| 54: front cover | 55: front cover hole |
| 56: rear cover | 57: rear cover hole |
| 58: resolver cover | 59: resolver cover hole |
| 60: resolver | 62: first pinion gear |
| 64: drive gear | 66: driven gear |
| 68: driven shaft | 70: second pinion gear |
| 72: supply passage | 74: exhaust passage |
| 76, 78: first, 2oil supply hole | 80: suction pipe |
| 82: planetary gear set | 84: sun gear |
| 86 and 88: first and second planet gears | 90: planet ring gear |
| 92: planet carrier | 100: motor shaft hole |
| 102: idle shaft | 104: bearing support cover |
| 106, 108: bearing | 140: second drive motor |
| 142: second motor housing | 148: second stator |
| 150: second rotor | 152: second motor shaft |
| 154: second front cover | 156: second rear cover |
| 158: second resolver cover | 160: second resolver |
| X1: horizontal line | X2: wheel axis |
| X3: center line of motor shaft | X4: center line of driven shaft |
| D1first separation distance | D2: second separation distance |
| D3: third separation distance | |

1. A power transmission device comprising:
a drive motor including a motor housing, a stator fixed in the motor housing and generating a magnetic field, a rotor disposed inside the stator in a radial direction while having a predetermined gap with the stator and rotated by the magnetic field generated by the stator, a motor shaft coupled to the rotor to be rotated together with the rotor and extending in a length direction, and a first pinion gear provided at one end of the motor shaft that protrudes outward from the motor housing;
a drum surrounding the drive motor and including a drum disk portion disposed on one surface in a wheel axis direction and a cylindrical portion extending from an outer diameter end of the drum disk portion in the wheel axis direction;
a drum cover coupled to the other surface of the drum in the wheel axis direction, and having a ring gear provided on an outer diameter portion of the drum cover and meshed with the first pinion gear;
a wheel hub installed with a tire, and coupled to the drum to be rotated together with the drum; and
a second pinion gear meshed with the ring gear.

2. The device of claim 1, further comprising:
a drive gear provided on the other end portion of the motor shaft that protrudes outward from the motor housing;
a driven shaft disposed in parallel with the motor shaft; and
a driven gear provided at one end portion of the driven shaft and meshed with the drive gear,
wherein the second pinion gear is disposed at the other end of the driven shaft.

3. The device of claim 2, wherein
a gear ratio of the drive gear and the driven gear is 1:1, and
a gear ratio of the first pinion gear and the second pinion gear is also 1:1.

4. The device of claim 2, wherein
the motor shaft and the driven shaft are spaced apart from a horizontal line in opposite directions,
a center line of the motor shaft is spaced apart from the horizontal line by a first separation distance, and
a center line of the driven shaft is spaced apart from the center line of the motor shaft by a second separation distance.

5. The device of claim 1, wherein
a drive motor further includes a planetary gear set disposed at the other end portion of the motor shaft to be operably connected to the motor shaft, and operably connected to the ring gear of the drum cover through the second pinion gear to transmit power of the motor shaft to the drum cover.

6. The device of claim 5, wherein
the planetary gear set is a double planet planetary gear set, and includes:
a sun gear fixedly installed at the other end portion of the motor shaft and rotated together with the motor shaft;
first and second planet gears operably connected to the sun gear to be rotated around the sun gear;
a planet carrier rotatably supporting the first and second planet gears, rotated by rotations of the first and second planet gears, and fixedly installed with the second pinion gear meshed with the ring gear; and
a planet ring gear fixed to the motor housing and having an inner peripheral surface gear-meshed with the second planet gear.

7. The device of claim 6, wherein
a motor shaft hole is formed in the length direction in the other end portion of the motor shaft, and the planet carrier extends in the length direction such that one end portion of the planet carrier is relatively rotatably inserted into the motor shaft hole, and
the number of teeth of the planet ring gear is twice the number of teeth of the sun gear.

8. The device of claim 1, further comprising
a second drive motor including a second motor housing, a second stator fixed in the second motor housing and generating a magnetic field, a second rotor disposed inside the second stator in the radial direction while having a predetermined gap with the second stator and rotated by the magnetic field generated by the second stator, a second motor shaft coupled to the second rotor to be rotated together with the second rotor and extending in the length direction, and a second pinion gear provided at the other end of the second motor shaft that protrudes outward from the second motor housing.

9. The device of claim 1, further comprising
an idle gear device rotated by the second pinion gear meshed with the ring gear rotated by the first pinion gear.

10. The device of claim 9, wherein
the idle gear device includes:
an idle shaft extending in the length direction, including one end and the other end, and having the second pinion gear, which is meshed with the ring gear, fixedly installed at the other end of the idle shaft; and
a bearing support cover fixedly installed at the other end of the motor housing,
wherein the other end of the idle shaft penetrates through the bearing support cover, and the bearing support cover rotatably supports the idle shaft.

11. The device of claim 10, wherein
a motor shaft hole is formed in the length direction in the other end portion of the motor shaft, and one end portion of the idle shaft is relatively rotatably inserted into the motor shaft hole.

12. The device of claim 9, wherein
the drive motor and the idle gear device are disposed on a horizontal line, or disposed to be spaced apart from the horizontal line.
